(19) United States
(12) Patent Application Publication
(10) Pub. No.: US 2015/0016887 A1
(43) Pub. Date: Jan. 15, 2015

(54) WALKING SYSTEM AND METHOD ADAPTED FOR USE ON A DRY-DOCK TO TRANSPORT A SHIP

(71) Applicant: Columbia Industries LLC, Hillsboro, OR (US)

(72) Inventors: Paul Schmidt, Carlton, OR (US); Ken Van Raden, Hillsboro, OR (US); Nathan Georges, Hillsboro, OR (US); David Hogenkamp, Molalla, OR (US)

(21) Appl. No.: 13/940,160

(22) Filed: Jul. 11, 2013

(51) Int. Cl. B60P 3/10; B63C 1/02; B62D 57/032

(52) U.S. Cl. CPC B60P 3/10; B62D 57/032; B63C 1/02
USPC 405/3; 180/8.6; 405/4; 414/800

(57) ABSTRACT

A dry-dock walking machine for installation on the deck surface of a dry-dock is operable for transporting a ship to a selected location relative to the dry-dock. There is provided a plurality of laterally spaced-apart, parallel support beams rigidly interconnected and dimensioned to extend transversely beneath the ship and across at least a portion of its width to engage its hull and support it above the deck surface. A lifting jack assembly is mounted on each end of each support beam, and they are spaced apart so that each support beam has a lifting jack assembly positioned adjacent each lateral side of the ship. A stabilizer mechanism is mounted on each support beam adjacent each lifting jack assembly operable for selectively engaging a lateral side the ship's hull to establish and maintain lateral stability of the ship relative to the support beams.

### BACKGROUND OF THE DISCLOSURE

The present disclosure is directed to that class of large machines known as walking systems which are used to transport massive and heavy loads, upwards of thousands of tons, over a surface area, such as the ground, snow, gravel or sand, etc. Conventional walking systems are designed as non-wheeled power-driven vehicles fabricated from iron and steel and have found particular utility in carrying and sequentially transporting huge structures such as oil drilling rigs and their support or service modules to pre-drilled, ground-installed conductor pipes. This is done prior to drilling well bores in fields undergoing oil exploration, or over existing well bores in previously-worked old fields, or the like.

The present disclosure is directed to a walking system uniquely constructed and adapted for use on a dry-dock. The walking system, suitably mounted on the dry-dock, may receive a ship and transport it along the dry-dock's deck surface to a selected location, such as a shipyard area, remote from the dry-dock. Here, the ship may undergo necessary repairs, cleaning, painting or other work, isolated from the dry-dock, which now may be used to receive another ship. This new ship may in turn be subsequently transported to the shipyard area as well. In this manner the dry-dock may be continuously freed and used to receive ships, and need not be occupied with any single ship. It is believed that the dry-dock now may find a substantial increase in its ability to generate income over what has heretofore been possible. The walking system of the present disclosure may transport a ship not only along a straight line, but also may be steered, to direct the ship to a desired location in a shipyard area or the like.

### Examples of Prior Art Walking Machines and Systems

There are numerous examples of walking machines and systems which have been designed for use in moving drilling rigs for positioning over well bores during oil exploration. An example of a known walking machine is disclosed in U.S. Pat. No. 6,581,525 where a load-carrying transport apparatus for moving a heavy load, such as an oil drilling rig, over a surface includes a substructure for carrying the load, a track member positioned on the surface adjacent the substructure and a plurality of lift assemblies mounted on the substructure selectively operable for extension toward the surface to engage the track member and raise the substructure above the surface so that it is carried on the track member. The lift assemblies are also operable for retraction to lower the substructure onto the surface.

A shifter mechanism disposed adjacent to the substructure and the track member is selectively operable for displacing the substructure along the track member when the lifting assemblies have been extended toward the surface to raise the substructure above the surface. The shifter mechanism is also operable for displacing the track member on the surface relative to the substructure when the lifting assemblies have been retracted and disengaged from the track member. The track member is dimensioned to provide a steering area and at least one of the lifting assemblies is selectively positionable to a predetermined angle within a range for moving in the steering area along the track member so that the load-carrying apparatus can be steered along a selected direction.

Another example of a walking machine is disclosed in U.S. Pat. No. 5,921,336 in which a drilling rig substructure is provided with a plurality of lifting jacks, and each lifting jack is connected to a jack pad. Roller assemblies are mounted at the lower end of the lifting jacks and each jack pad has a center beam that the roller assemblies engage. The jack pads are rotatable in 360° about a vertical axis. A push-pull mechanism extends between each jack pad and each roller assembly to move the rollers horizontally in relation to the jack pad. In operation, when it is desired to move to a well bore, the lifting jacks are extended, forcing the jack pad against the ground.

Continued extension causes the upper end of the lifting cylinder to raise the substructure and accompanying drilling rig to move from ground level. The lifting jacks now remain in the extended position and the push-pull mechanisms are then actuated to move the substructure in a given direction. The lifting jacks are then retracted so that the substructure returns to the ground and the jack pad is then raised and moved to a new position.

A further example of the prior art is U.S. Pat. No. 7,819,209 which describes a guided transport unit for moving a superstructure in angular movements over a surface. There is disclosed a skid pad, a vertical displacing member engaged with the skid pad, a base operatively associated with the vertical displacing member, and a directional actuator. The base includes a planar element for engaging the surface over which the superstructure is transported, and a carrier for moving the vertical displacing member and skid pad relative to the surface. The disclosure shows that the side walls of the skid pads are provided with openings to enable the guided main structures to pivoted to extend at least partially outside of the skid pads.

### SUMMARY OF THE DISCLOSURE

As noted above, the present disclosure is directed to a walking machine for use on a dry-dock. A uniquely designed walking machine is disclosed for use in a method for loading a ship onto the deck surface of a floating or other type of dry-dock and transporting the ship to a selected location relative to the dry-dock. This method contemplates that the dry-dock is initially positioned so that its deck surface is raised above the water, and a walking machine according to the present disclosure is then installed on the deck surface and oriented for receiving a ship. The deck surface is submerged so that both it and the walking machine are maintained underwater at a depth sufficient to enable a ship to be floated into a position above the deck surface and aligned above the walking machine

The next step requires elevating the deck surface so that the walking machine engages and cradles the ship's hull. The deck surface is now further elevated until the ship and the walking machine are raised above the water surface along with the deck surface. The walking machine is provided with mechanism for establishing lateral stability of the ship relative to the walking machine The walking machine may now be actuated to move the ship in a selected direction relative to the deck surface of the dry-dock for eventual transport to an area remote from the dry-dock. After work has been completed on the ship, the walking machine may be used to transfer the ship back to the dry-dock for eventual return to the water.

While the above method and the design of the walking system are useful in the context of dry-dock operations, the method and walking system may be used for moving any load, not just ships.

### BRIEF DESCRIPTION OF THE DRAWINGS

FIG. 1 is a schematic top plan view of how the present disclosure contemplates that a ship may be floated into a dry-dock, loaded onto the walking machine and transported to a shipyard area for repairs, cleaning, painting or other work; the ship is also shown being moved by the walking machine in different directions, depending on requirements;

FIG. 2 is a schematic side elevational view of a ship, stern on left, bow on right, shown in outline, supported on the walking machine's multiple spaced-apart support beams, shown initially positioned on the deck surface of a dry-dock;

FIG. 3 is a schematic top plan view of a ship, shown in outline, positioned on the support beams with stabilizing means shown in open positions prior to being clamped to lateral sides of the ship's hull;

FIG. 4 is a is a schematic top plan view of a ship, shown in outline, positioned on the support beams with stabilizing means shown in closed or clamped positions against lateral sides of the ship's hull for stabilizing the ship prior to transportation by the walking machine;

FIG. 5 is a perspective view, taken from the starboard side of a ship, near the stern, showing several of the walking machine's support beams supporting the ship, shown in outline, with spaced-apart lifting jack assemblies shown positioned adjacent opposed ends of the support beams, with associated stabilizing means shown in their first, open positions prior to being clamped to lateral sides of the ship's hull;

FIG. 6 is an enlarged perspective view of part of an end section of a support beam showing part of a lifting jack assembly with an adjacent stabilizing means shown in its first, open position prior to being clamped to a lateral side of a ship;

FIG. 7 is an enlarged end view of a support beam, with strut members cut away, showing mounting of a lifting jack assembly and the arrangement of its components, including a hydraulic cylinder, piston in its retracted position, roller assembly mounted to bottom of piston, movable foot plate mounted to roller assembly, travel cylinder mounted to foot plate, with extendable/retractable rod connected to roller assembly, and ring gear mounted to roller assembly shown with drive motor and spur gear for selectively imparting angular positioning of the roller assembly and the foot plate;

FIGS. 8A-8F are end views of a pair of adjacent support beams illustrating operation of adjacent lifting jack assemblies during a travel cycle of the walking machine with the load representing the ship shown schematically; and

FIG. 9 is a view, shown in perspective without the ship, of a pair of adjacent support beams followed by a description of the operation of adjacent lifting jack assemblies during a travel cycle of the walking machine

### DETAILED DESCRIPTION OF THE PREFERRED EMBODIMENT

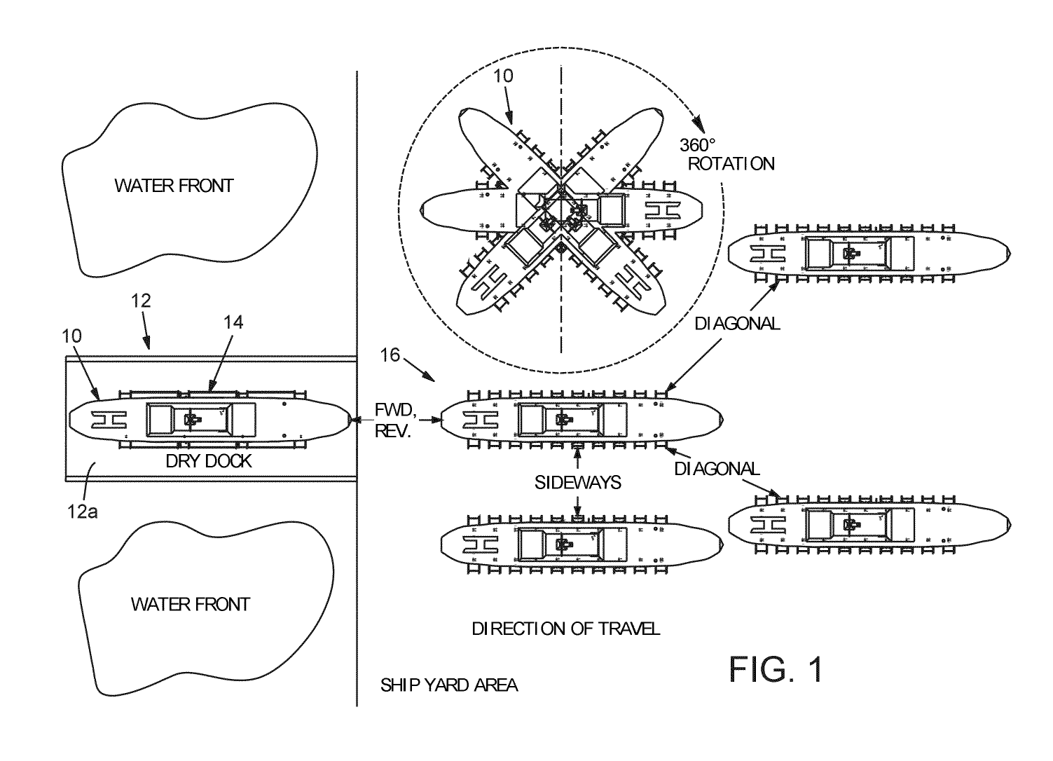

The present disclosure is directed to a walking machine for use on a dry-dock, and the overall goal of moving a large-tonnage ship, such as transport, freighter, cruise liner or the like, from a dry-dock to a remote area, such as a shipyard area can be initially appreciated from a viewing of the top plan view of FIG. 1. As shown, a ship, generally indicated at 10, has been floated into position in a dry-dock 12, and has been loaded onto the uniquely designed walking machine generally shown at 14 which has been installed on deck surface 12a. The dry-dock is shown in the water, and a land area such as a shipyard generally indicated at 16 is shown at to the right of the dry dock. The ship is to be transported by the walking machine and moved to a desired location in the shipyard. The walking machine is constructed so that it can be operated efficiently to move the ship in forward or reverse directions, or translate it laterally or even rotate it or move it in a selected direction offset from a straight path, as shown in FIG. 1.

The method and structure of the walking machine to be described contemplates that the dry-dock is initially positioned so that its deck surface is raised above the water, and the walking machine is then installed on the deck surface and oriented for receiving the ship. The deck surface is submerged so that both it and the walking machine are maintained underwater at a depth sufficient to enable the ship to be floated into a position above the deck surface and aligned above the walking machine. The deck surface is then raised so that support beams on walking machine 14 engage and cradle the ship's hull. The deck surface is now further elevated, or water drained until the ship and the walking machine and deck surface are raised or otherwise positioned above the water surface. The walking machine is provided with mechanism for establishing lateral stability of the ship relative to the walking machine, and generally, that stabilizing system will be activated once the ship is above water, but in some cases, the stability mechanism may be activated when the hull still has portions underwater.

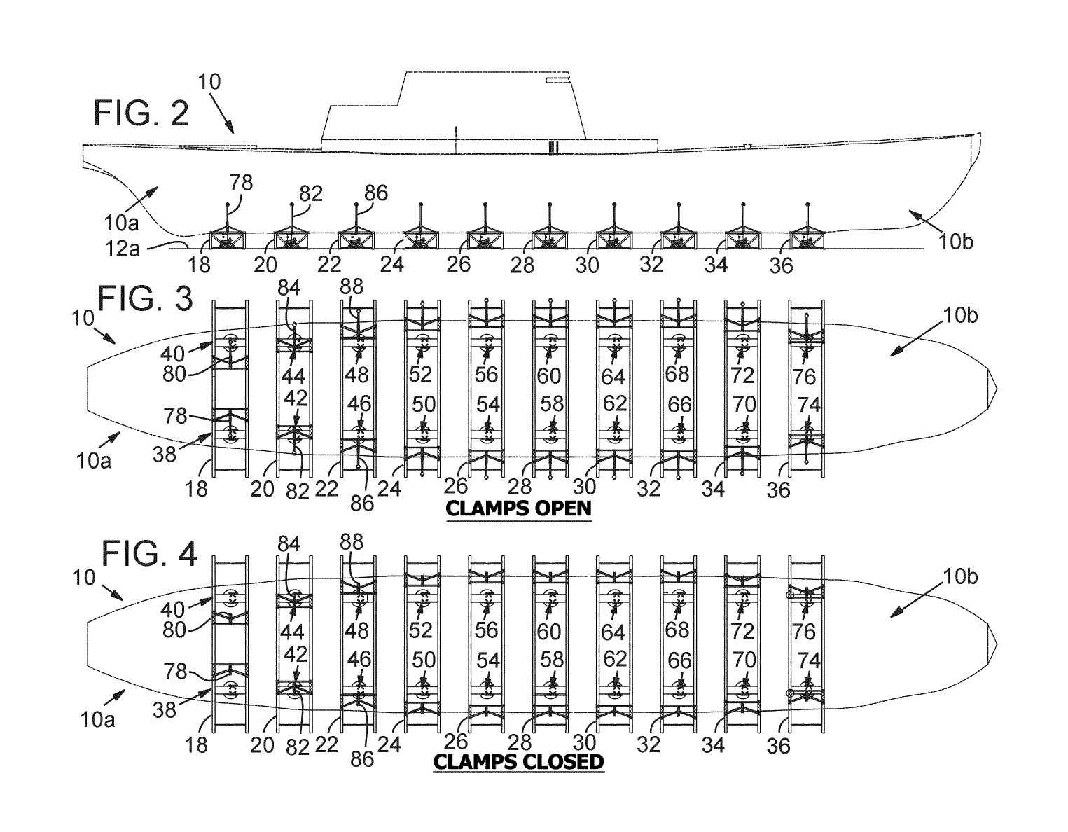

As shown in FIG. 2, ship 10 has been raised above the water and is supported by walking machine 14 which includes a plurality of laterally spaced-apart, parallel support beams such as indicated at 18-36, which have been installed on deck surface 12a, as described, and run generally along the length from stern area 10a to bow area 10b. The support beams are rigidly interconnected, although not shown here, by a rigid framework of struts and bars. The support beams themselves may be constructed with a framework forming individual box beams. The support beams are dimensioned to extend transversely beneath the ship, as shown in both FIGS. 3 and 4, and across at least a portion of its width or beam to engage its hull and support it above deck surface 12a. The actual number of support beams required, and their spacing will depend on the overall tonnage of the ship and its dimensions and configuration, including that of the waterline.

Both FIGS. 3 and 4 show spaced-apart matched sets of lifting jack assemblies mounted on each support beam, adjacent each end thereof, so that each support beam has such an assembly positioned adjacent each lateral side of the ship. For example, mounted on support beam 18 are spaced-apart matched sets of lifting jack assemblies 38 and 40. Likewise, each of the other support beams includes spaced-apart matched sets of these assemblies, noted as follows:

| Support Beam | Lifting Jack Assemblies |
|---|---|
| 18 | 38 and 40 |
| 20 | 42 and 44 |
| 22 | 46 and 48 |
| 24 | 50 and 52 |
| 26 | 54 and 56 |
| 28 | 58 and 60 |
| 30 | 62 and 64 |
| 32 | 66 and 68 |
| 34 | 70 and 72 |
| 36 | 74 and 76 |

The detailed construction of the lifting jack assemblies will be described, but for now it is understood that each includes a hydraulic cylinder operating an extendable/retractable piston connected to a foot plate, with each hydraulic cylinder being selectively operable for extending its piston to push its foot plate against the deck surface to raise its support beam so that the ship may be supported above the deck surface, while also being retractable for disengaging its foot plate from the deck surface.

It will be further noted that a pair of spaced-apart stabilizer mechanisms are mounted on each support beam adjacent each lifting jack assembly operable for selectively engaging a lateral side the ship's hull to establish and maintain lateral stability of the ship relative to the support beams. For example, support beam 18 is provided with spaced-apart stabilizer mechanisms 78 and 80; support beam with stabilizer mechanisms 82 and 84; and support beam 22 with stabilizer mechanisms 86 and 88. Similarly the other support beams are provided with spaced-apart stabilizer mechanisms. It is to be noted that the distance between stabilizer mechanisms on a particular support beam may vary from that of others.

For example, it can be seen that the distance between stabilizer mechanisms 78 and 80 is noticeably closer than that between stabilizer mechanisms 82 and 84 on support beam 20, and closer than on the majority of the others. That is because nearer the stern and the bow, a ship may be narrower and neck down more steeply, and certain stabilizer mechanisms may have to be moved inwardly to effect more efficient clamping action. Each of the stabilizer mechanisms includes a clamp arm, selectively operable between a first open or unclamped position, and a second closed or clamped position against the lateral side of the ship's hull. As shown in FIG. 3, the stabilizer mechanisms are all shown in their first open position, or “clamps open,” whereas in FIG. 4 they are shown having been actuated to their second closed or “clamps closed” position, effectively gripping the lateral sides of the ship's hull.

With the ship secured by the stabilizer mechanisms, it is in operative position to be moved in a selected direction relative to the deck surface of the dry-dock for eventual transport to an area remote from the dry-dock. After work has been completed on the ship, the walking machine may be used to transfer the ship back to the dry-dock for eventual return to the water.

### The Support Beams and Stabililizer Mechanisms

What now follows are details of the construction of the support beams and stabilizer mechanisms. Included further on will be a description of the lifting jack assemblies for raising and supporting the support beams and details about shifter mechanisms operable to substantially continuously maintain the support beams above the support surface to displace the support beams and the ship relative to the deck surface in a selected direction. This occurs when the lifting jack assemblies have raised the support beams and the ship above the deck surface. It is believed that the disclosure here provides for the first time operation of a walking machine not only for use in connection with a dry-dock, but also for eliminating the need of support beams to be repeatedly lowered to a surface during a walking sequence, in the manner required in conventional walking machines and systems.

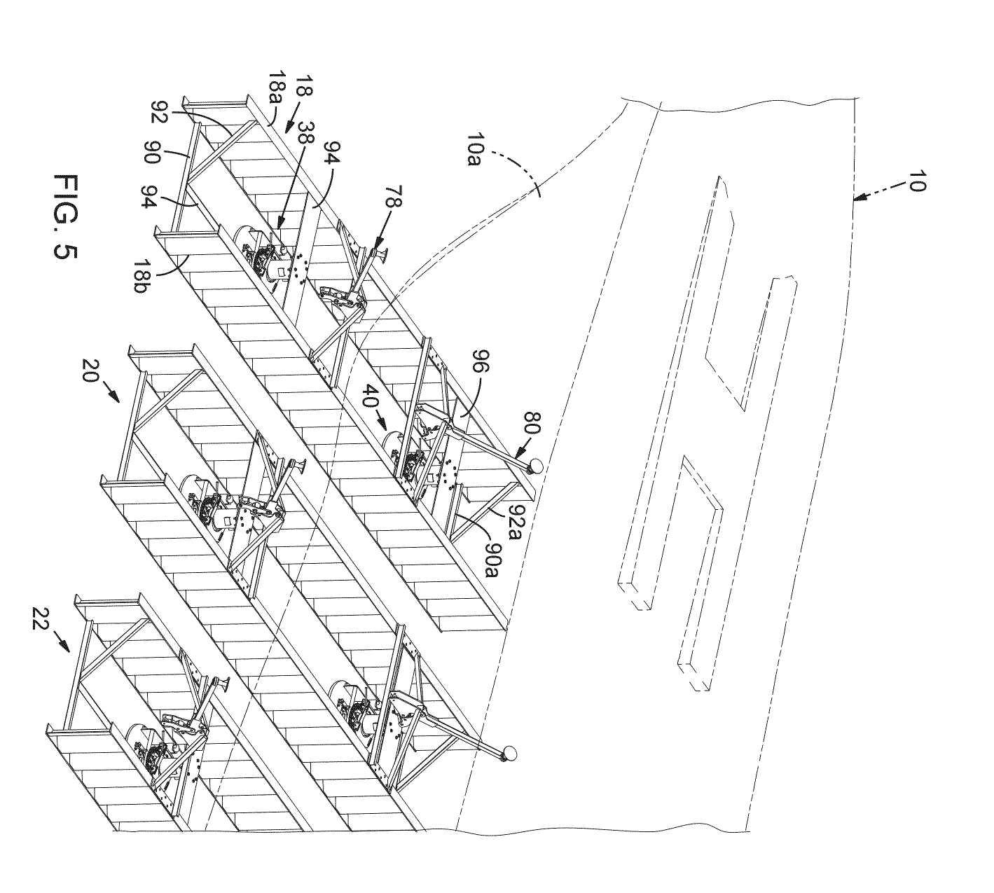

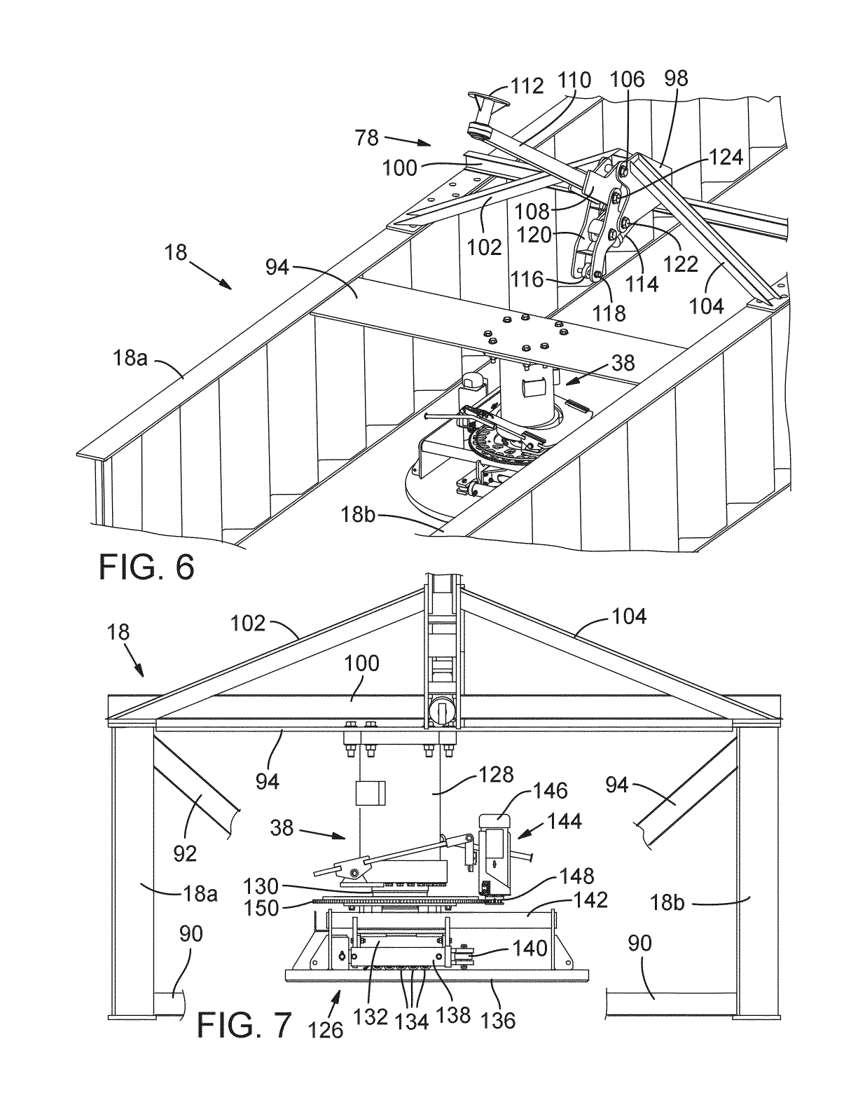

FIG. 5 is a perspective, enlarged view of support beams 18 and 20, and a partial view of support beam 22, and shows mounting of the lifting jack assemblies and the stabilizer mechanisms. The construction is essentially the same for all the support beams and components, and so only that shown that shown at 18 will be described. Support beam 18 is shown with opposed walls, of corrugated steel construction, indicated at 18a and 18b, and only minimal bracing and struts are shown at 90, 92 and 94 on the end most adjacent, and 90a, 92a on the opposite end. As stated previously, it may be most practical to fabricate support beam 18 and the others, as a box beam designed to shoulder their appropriate share of very heavy tonnage. As shown in FIG. 5, lifting jack assemblies 38 and 40 are mounted to support beam 18 by transverse plates or beams 94 and 96, respectively, which span between opposed walls 18a and 18b. FIG. 5 is representational, more massive support structure may well be required than that which is impliedly shown in FIG. 5 or any of the other drawing figures. The stabilizer mechanisms are shown at 78 and 80, deployed in their first open positions, prior to being shifted into their second or closed positions for clamping. Reference is now directed to FIGS. 6 and 7, and first to FIG. 6 for more detail focusing on the stabilizer mechanisms, and that shown at 80.

All the stabilizer mechanisms are substantially the same, and their mountings are similar, as well as their operation and component parts. Stabilizer mechanism 78 includes a clamping assembly which includes a dual-plated mount or bracket 98 rigidly secured to a cross member 100 which in turn is mounted to and spans between walls 18a and 18b of the support beam. A pair of upwardly-inclined struts or braces 102 and 104 are secured rigidly to walls 18a and 18b, respectively, and their connection to bracket 98 supports it rigidly in position in conjunction with cross member 100. Bracket 98 is pivotally connected at 106 via a bracket 108 to which is secured to an elongate clamp arm 110. Extending inwardly for suitable engagement with a side of the hull is a plate 112. A power-driven actuator, such as a hydraulic cylinder 114 has an extendable/retractable rod 116 pivotally connected at 118 to an over-center bell crank mechanism 120 which in turn is pivotally connected at 122 to bracket 98 and pivotally connected also at 124 to bracket 108 which mounts clamp arm 110.

Hydraulic cylinder 118 is selectively operable for deploying or pivotally moving clamp arm 110 between its first open position disengaged for receiving a ship, as shown in FIG. 6, to its second closed position for exerting and maintaining a clamping force against a lateral side of the ship's hull, which force is transferred to the support beam to restrict movement of the ship relative to the support beam.

### The Lifting Jack Assemblies and Shifter Mechanisms

Attention will now be directed to FIG. 7 which is an end view of support beam 18, where lifting jack assembly 38 mounted on that beam is shown along with a shifter mechanism, as will be described. The lifting jack assemblies and the shifter mechanisms are essentially the same throughout on all support beams; therefore only a discussion of lifting jack assembly 38 and its components, and a shifter mechanism shown generally at 126 will be described.

Lifting jack assembly 38 includes a hydraulic cylinder 128 which is mounted to beam 94 and is operable for actuating an extendable/retractable piston 130 which in turn is connected to a roller assembly 132 having a plurality of rollers 134 which engage a foot plate 136. Shifter mechanism 126 includes a power-driven travel cylinder 138 for selectively actuating a rod 140 (shown retracted in FIG. 7) which has its end connected to roller assembly 132. On the opposite side, there is another travel cylinder/rod construction, similarly connected to the roller assembly, thus providing a pair of travel cylinders which are selectively operable in unison to provide relative movement between the roller assembly and the foot plate when suitably actuated. A pair of orienting guide bars, one of which is shown at 142 (the other is hidden on the other side in FIG. 7) are provide for maintaining alignment.

The shifter mechanisms as a group are operable to displace the support beams and the ship relative to the foot plates and along the deck surface in a selected direction when the lifting jack assemblies have extended their associated pistons to push the foot plates against the deck surface to raise its support beam and support the ship above the deck surface.

As mentioned with respect to the view presented in FIG. 1, the present disclosure includes a system with a steering mechanism designed so that the ship, or any load for that matter, may be steered in a selected one of multiple modes, namely, longitudinal steering, simple steering, transverse steering, complementary steering, crab steering and circular steering. To implement the orientation necessary for each of these steering or traveling modes, the present disclosure, as shown in FIG. 7, utilizes a steering mechanism 144 which includes a motor 146 operable for driving a spur gear 148 which imparts a selected rotation to a ring gear 150. The ring gear is mounted on the lifting jack assembly by its connection or mounting to roller assembly 132, which as mentioned previously is connected to piston 130. Ring gear 150 therefore is operable for rotation by action of motor 146 and spur gear 148 to orient the foot plate in a selected direction. The steering mechanism is selectively operable for rotating the roller assembly and foot plate as a unit about a vertical axis extending through the piston to orient and fix the direction of travel of support beam 38 in a preselected direction. This same basic construction is provided on all the lifting jack assemblies on all the support beams.

### The Walking System Adapted for Use on a Dry-Dock

The present disclosure utilizes the support beam construction as described above to provide a method for loading a ship onto the deck surface of a floating dry-dock and transporting the ship to a selected location relative to the dry-dock. This is accomplished by using a plurality of laterally spaced-apart, parallel support beams rigidly interconnected and dimensioned to extend transversely beneath the ship and across at least a portion of its width to engage its hull and support it above the deck surface. The use of transversely extending support beams enables the following steps to be implemented to load a ship onto a walking in a dry-dock.

Initially, the dry-dock is positioned so that its deck surface is raised above the water surface. This enables the walking machine described here to be installed on the deck surface of the dry-dock, and oriented to receive a ship. The deck surface must be submerged, along with the installed walking machine beneath the surface of the water. Now, a ship may be moved to a position above the deck surface and aligned with the walking machine; elevation of the deck surface enables the support beams of the walking machine to engage and cradle the ship's hull. Further elevation of the deck surface continues until the ship and the walking machine are raised above the water surface along with the deck surface. Here lateral stability of the ship relative to the walking machine is established by actuating the stabilizing mechanisms provided on each of the support beams. The walking machine may now be operated to move the ship in a selected direction relative to the deck surface of the dry-dock, and moved off the dry-dock to a shipyard or other area.

The walking machine's unique construction described here, which utilizes a plurality of laterally spaced-apart, rigidly interconnected support beams positioned parallel to one another and which extend transversely beneath the load and support it above the surface provides an operational advantage. The support beams to not have to be repeatedly lowered to a surface during a walking cycle, the walking machine may essentially be continuously operated to transport a load. The tranverse positioning of the support beams, together with lifting jack assemblies mounted adjacent each end of each support beam, enable implementation of a unique sequence of lifting and shifting. The support beams and their load may be transported in a walking sequence without the necessity of lowering the support beams to the surface.

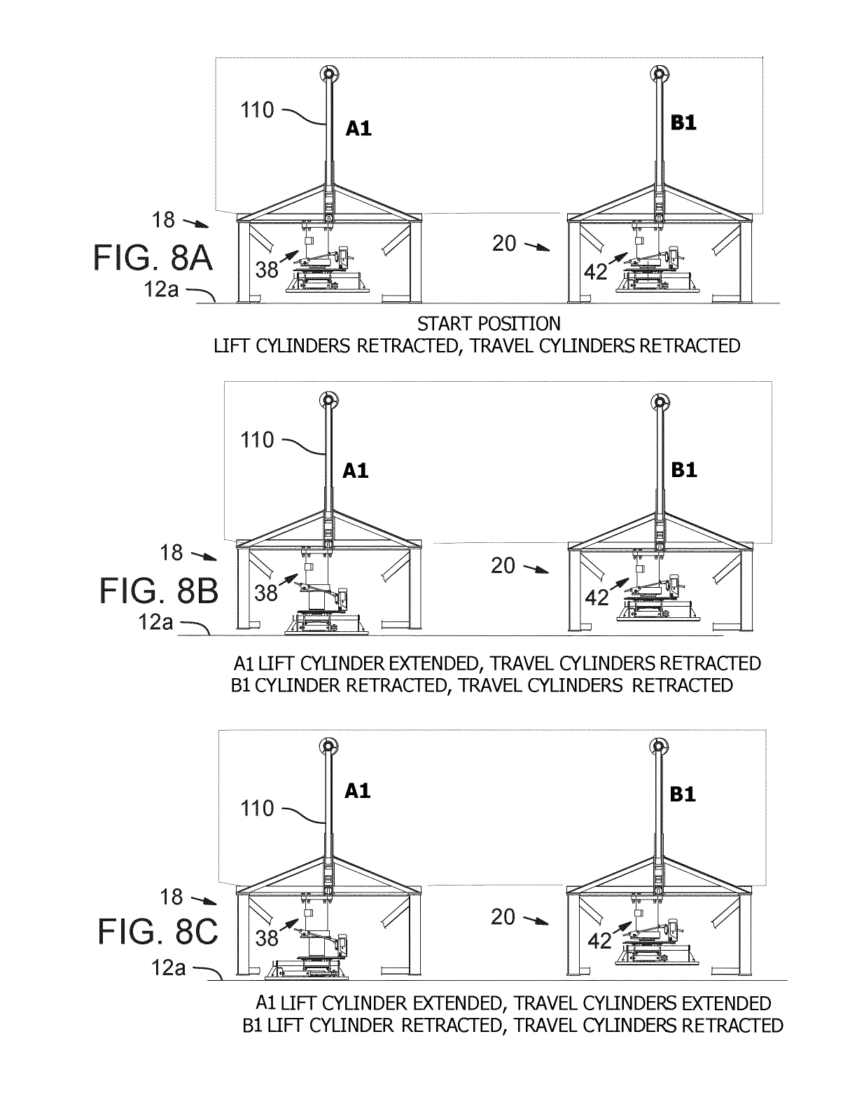

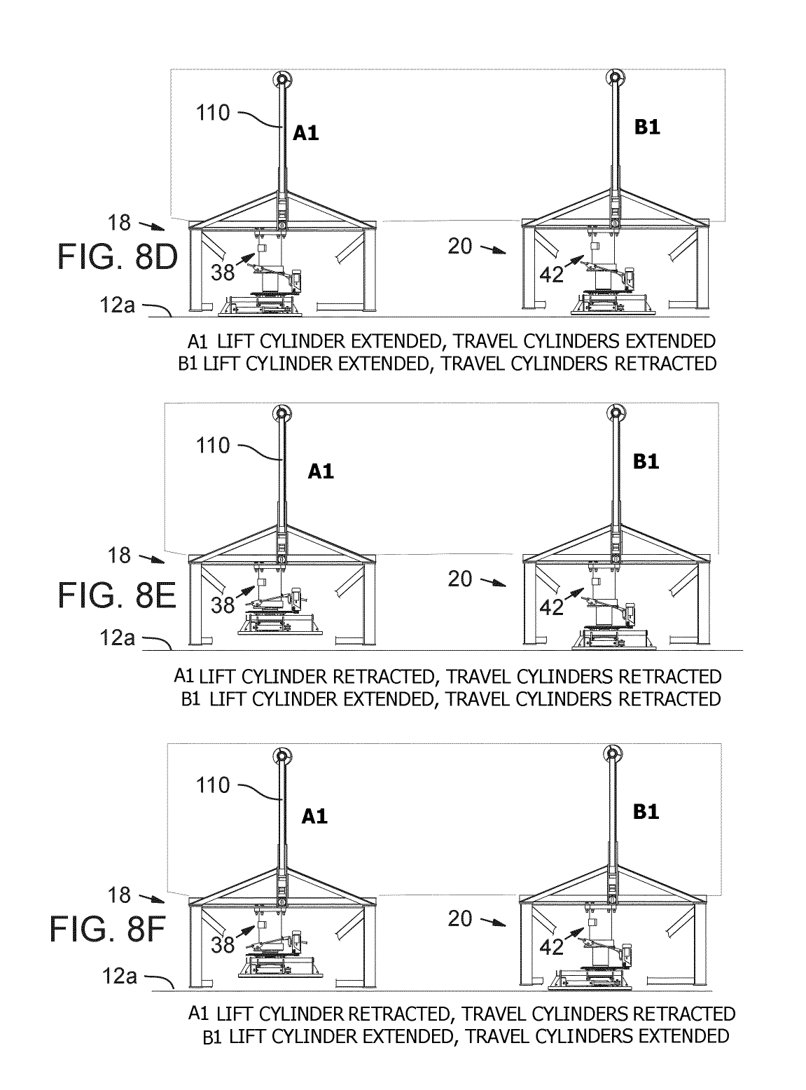

This method can initially be appreciated by viewing FIGS. 4 and 8A, which show that initially, the load, in this case a ship, is supported on the support beams which are loaded onto the deck surface, transferring the tonnage of the ship to the deck surface. All the lifting assemblies are retracted, this is a so-called “start position,” prior to initiating the walking sequence, as shown by two of the support beams 18 and 20 in FIG. 8A. All the travel cylinders are retracted as well, again as shown in FIG. 8A. The first step is to actuate first diagonally-opposed lifting jack assemblies on adjacent support beams to extend their pistons and engage their foot plates against the surface to raise the support beams and the load above the surface. Looking at FIG. 4, it can be seen that these first diagonally-opposed lifting jack assemblies on adjacent support beams, which are actuated to extend their pistons are indicated at 38, 44, 46, 52, 54, 60, 62, 68, 70 and 76 (see FIG. 8B also). This “zig-zag” or diagonal pattern, when seen from above in FIG. 4, provides a lifting force on all the support beams, which are rigidly interconnected. But second diagonally-opposed lifting jack assemblies 40, 42, 48, 50, 56, 58, 64, 66, 72 and 74 on adjacent support beams are maintained with their pistons retracted and foot plates disengaged from the surface, represented by the single beam shown on the right indicated at B1 in FIG. 8B.

The next step in the sequence, is to displace the support beams in unison and the ship mounted thereon in the direction of travel. This is done by actuating all the travel cylinders on first diagonally-opposed lifting jack assemblies 38, 44, 46, 52, 54, 60, 62, 68, 70 and 76 which will shift the ship to the right, as shown in FIG. 8C, thereby transporting the ship along the deck surface in a selected direction a preselected distance. The travel cylinders on the second diagonally-opposed lifting jack assemblies 40, 42, 48, 50, 56, 58, 64, 66, 72 and 74 remain retracted during this sequence.

Next, with reference again to FIG. 4, and the exemplary end views of the support beams shown in FIG. 8D, the second diagonally-opposed lifting jack assemblies 40, 42, 48, 50, 56, 58, 64, 66, 72 and 74 are extended to engage the deck surface, and take the load from the first diagonally-opposed lifting jack assemblies, which are then retracted, in a smooth sequence, as shown in FIG. 8E. The travel cylinders of the second-diagonally opposed lift are then actuated, as shown in FIG. 8F, to sequentially and continuously transport the ship in the preselected direction of travel. This is all done without the support beams being lowered to the deck surface or other surface, such as the shipyard or other area, during transport.

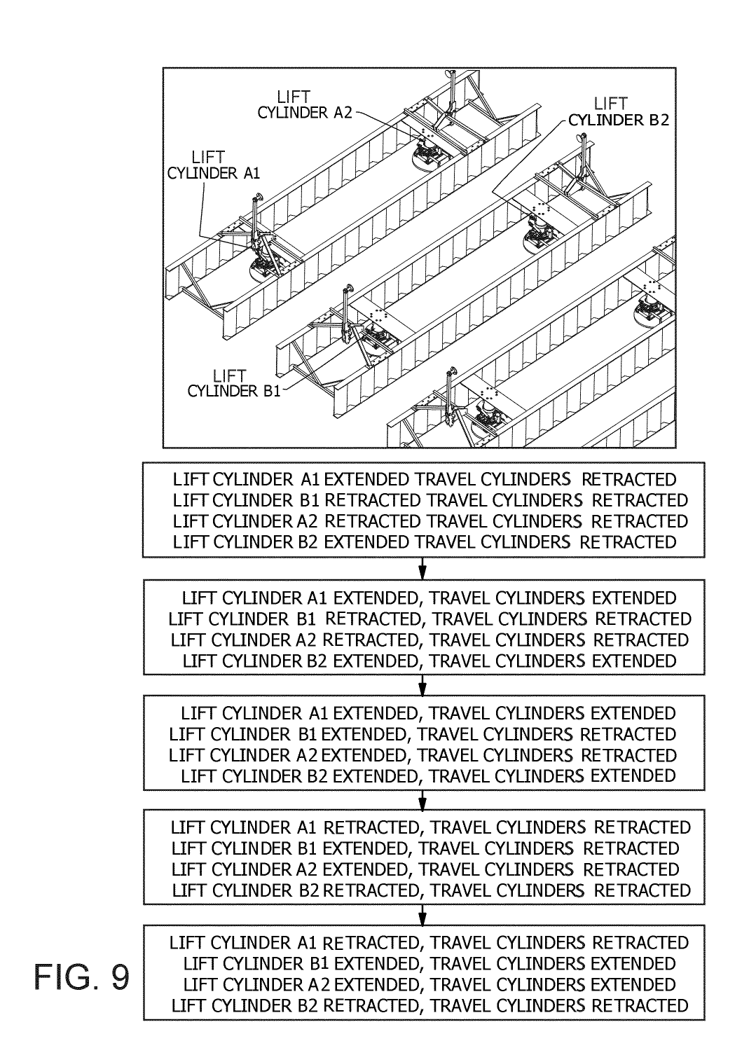

The sequence as above described can be executed continuously, and the time-consuming steps of repeatedly having to raise and lower the support beams during transport in a walking method are eliminated. The operation of the sequence of the present disclosure is also depicted in FIG. 9, which shows in perspective adjacent support beams and presents in a flow chart the sequence as described above.

What is claimed is:

1. A dry-dock walking machine for installation on the deck surface of a dry-dock operable for transporting a ship to a selected location relative to the dry-dock comprising:
a plurality of laterally spaced-apart, parallel support beams rigidly interconnected and dimensioned to extend transversely beneath the ship and across at least a portion of its width to engage its hull and support it above the deck surface;
a lifting jack assembly mounted on each end of each support beam; spaced apart so that each support beam has a lifting jack assembly positioned adjacent each lateral side of the ship, wherein each lifting jack assembly includes a hydraulic cylinder operating an extendable/retractable piston connected to a foot plate, each hydraulic cylinder being selectively operable for extending its piston to push its foot plate against the deck surface to raise its support beam and support the ship above the deck surface and retractable for disengaging its foot plate from the deck surface;
a stabilizer mechanism mounted on each support beam adjacent each lifting jack assembly operable for selectively engaging a lateral side the ship's hull to establish and maintain lateral stability of the ship relative to the support beams; and
a power-driven shifter mechanism mounted on each lifting jack assembly, each being selectively operable to displace the support beams and the ship relative to the foot plates and along the deck surface in a selected direction when the lifting jack assemblies have raised the support beams and the ship above the deck surface.

2. The dry-dock walking machine of claim 2 wherein each stabilizer mechanism includes a clamping assembly selectively operable between a first open position disengaged for receiving a ship and a second closed position for engaging and exerting a clamping force against a lateral side of the ship's hull which force is transferred to a support beam to restrict movement of the ship relative to the support beams.

3. The dry-dock walking system of claim 2 wherein each clamping assembly includes a clamp arm mounted to a support beam and a power-driven actuator selectively operable for displacing the clamp arm from its first open position to its second closed position to exert the clamping force against a lateral side of the ship's hull.

4. The dry-dock walking system of claim 3 wherein the each clamp arm is an elongate, rigid member mounted on its support beam pivotally movable from its first open position to its second closed position for exerting and maintaining a clamping force against the ship's hull.

5. The dry-dock walking system of claim 4 wherein each support beam is formed as a structurally rigidified box beam for mounting a lifting jack assembly at opposite ends thereof, thereby enabling positioning of a lifting jack assembly on each support beam generally on lateral sides of the hull of the ship.

6. The dry-dock walking machine of claim 5 wherein each lifting assembly includes:
a roller assembly provided with rollers and mounted to the piston, wherein the foot plate is mounted on the roller assembly for selective engagement and selective longitudinal shifting along and the rollers;
wherein each shifter mechanism includes a power-driven travel cylinder having an extendable/retractable rod, wherein the travel cylinder is connected to the foot plate and the extendable end of the rod is connected to the roller assembly; and
wherein the travel cylinder is selectively operable for extending the rod to shift the roller assembly and its associated support beam in a first direction relative to the foot plate, and for retracting the rod to shift the roller assembly and its associated support beam in a second direction relative to the foot plate opposite to the first direction.

7. The dry-dock walking machine of claim 6 wherein a steering mechanism is connected to each roller assembly selectively operable for rotating the roller assembly and foot plate as a unit about a vertical axis extending through the piston to orient and fix the direction of travel of the main beams in a preselected direction.

8. The dry-dock walking system of claim 7 wherein each foot plate on each lifting jack assembly is selectively positionable about a vertical axis the cylinder to preselect orient the foot plate for steering the support beams and the load in a selected direction for directional steering.

9. The dry-dock walking system of claim 8 wherein a ring gear mounted on the lifting jack assembly is operable for orienting the foot plate in a selected direction.

10. A method for loading a ship onto the deck surface of a floating dry-dock and transporting the ship to a selected location relative to the dry-dock comprising:
positioning the dry-dock so that its deck surface is raised above the water surface;
installing a walking machine on the deck surface and orienting it for receiving a ship;
submerging the deck surface and the walking machine beneath the surface of the water;
moving a ship to a position above the deck surface and aligning it with the walking machine;
elevating the deck surface so that the walking machine engages and cradles a the ship's hull;
elevating the deck surface further until the ship and the walking machine are raised above the water surface along with the deck surface;
establishing lateral stability of the ship relative to the walking machine; and
actuating the walking machine to move the ship in a selected direction relative to the deck surface of the dry-dock.

11. A method for transporting a load over a surface comprising:
installing a plurality of laterally spaced-apart, rigidly interconnected support beams on the surface positioned parallel to one another to extend transversely beneath the load and support it above the surface;
providing a lifting jack assembly adjacent each end of each support beam, spaced apart so that each support beam has a lifting jack assembly positioned adjacent each lateral side of the load, wherein each lifting jack assembly includes a hydraulic cylinder operating an extendable/retractable piston connected to a foot plate, each hydraulic cylinder being selectively operable for extending its piston to push its foot plate against the surface to support the load spaced from the surface and retractable for disengaging its foot plate from the surface;
actuating first diagonally-opposed lifting jack assemblies on adjacent support beams to extend their pistons and engage their foot plates against the surface to raise the support beams and the load above the surface;
maintaining second diagonally-opposed lifting jack assemblies on adjacent support beams with their pistons retracted and foot plates disengaged from the surface; and
displacing the raised support beams relative to the surface-engaged foot plates thereby transporting the load along the surface in a selected direction a preselected distance.

12. The method of claim 11 including the additional steps of:
extending the pistons of the second diagonally-opposed lifting jack assemblies, thereby engaging their foot plates against the surface to maintain the support beams and load raised above the surface;
retracting the pistons of the first diagonally-opposed lifting jack assemblies, thereby disengaging their foot plates from the surface; and
displacing the support beams and the load relative to the surface-engaged foot plates thereby transporting the load along the surface in a selected direction a preselected distance.
